(19) United States
(12) Patent Application Publication
(10) Pub. No.: US 2016/0067788 A1
(43) Pub. Date: Mar. 10, 2016

(54) Adjustable Tool Holder

(71) Applicant: James C. Brown, Santa Clara, CA (US)

(72) Inventor: James C. Brown, Santa Clara, CA (US)

(21) Appl. No.: 14/825,046

(22) Filed: Aug. 12, 2015

Related U.S. Application Data
(60) Provisional application No. 62/046,922, filed on Sep. 6, 2014.

(51) Int. Cl. B23B 31/20

(52) U.S. Cl. CPC B23B 31/20; B23B 2231/04; B23B 2260/004

(57) ABSTRACT

An adjustable tool holder provides multiple degrees of adjustment to permit improved alignment of a cutting tool with the rotational axis of a rotary power tool. A shank has a proximal end for attachment to a tool mount and a distal end including a mounting flange and a tool shaft receiver. The tool shaft receiver includes a first plurality of flats. The mounting flange includes a second plurality of threaded apertures. An adapter head engages the mounting flange by attachment to the second plurality of threaded apertures. The adapter head has a third plurality of threaded apertures and corresponding adjustment to engage the corresponding first plurality of flats. The adapter head also has a fourth plurality of apertures to receive lock screws which engage the corresponding second plurality of threaded apertures of the mounting flange.

### STATEMENT OF RELATED APPLICATION(S)

The present application claims the benefit of priority based on U.S. Provisional Patent Application Ser. No. 62/046,922, filed on Sep. 6, 2014, in the names of James Brown and Steven H. Schwartzkopf, entitled “Dial-ables Tool Holder”, which is commonly owned herewith entirely by James C. Brown and the contents of which are hereby incorporated by reference as if set forth fully herein.

### TECHNICAL FIELD

The present disclosure relates generally to cutting tool holders for rotary power tools such as lathes and the like.

### BACKGROUND

In a rotary power tool as the term is used herein a workpiece rotates and a cutting tool is held in a more or less fixed position with respect to the workpiece during cutting operations (for example, the cutting tool may be moved about the rotational axis and in and out of the forward end of the rotating workpiece to accomplish the machining process). It is often difficult to precisely align the longitudinal axis of a cutting tool with the rotational axis of a rotary power tool. When the longitudinal axis of the cutting tool is not perfectly aligned with the rotational axis of the rotary power tool or set to a desired offset therefrom, the precision of the cuts rendered by the tool is compromised and additional load and wear is placed on the rotary power tool. In the past, special shims have been inserted at various locations in contact with the cutting tool or its mount to attempt to achieve alignment but such shimming is difficult to repeat and still yields a relatively imperfect solution. What is needed is an improved approach to aligning a cutting tool with the rotational axis of a rotary power tool.

### OVERVIEW

An adjustable tool holder provides multiple degrees of adjustment to permit improved alignment of a cutting tool with the rotational axis of a rotary power tool. A shank having a proximal end for attachment to a tool mount and a distal end including a mounting flange and a tool shaft receiver is provided. The tool shaft receiver has machined thereon a first plurality of flats. The mounting flange has machined therein a second plurality of threaded apertures. An adapter head is configured to engage the mounting flange by attachment to the second plurality of threaded apertures. The adapter head has a third plurality of threaded apertures machined therethrough and corresponding adjustment screws configured to engage the corresponding first plurality of flats of the tool shaft receiver. The adapter head also has a fourth plurality of apertures configured to receive lock screws which engage the corresponding second plurality of threaded apertures of the mounting flange. The adapter head is also configured to receive a cutting tool. Adjustment of the adjustment screws against the corresponding flats of the tool shaft receiver provides multiple degrees of adjustment of the adapter head and cutting tool with respect to the shank and mounting flange so as to bring the longitudinal axis of the cutting tool into alignment (or desired offset alignment) with the rotational axis of the rotary power tool.

The foregoing overview is merely a summary and thus may contain simplifications, generalizations and omissions of detail. Those persons of ordinary skill in the art will appreciate that the overview is illustrative only and is not intended to be in any way limiting.

### BRIEF DESCRIPTION OF THE DRAWINGS

The accompanying drawings, which are incorporated into and constitute a part of this specification, illustrate one or more exemplary embodiments and, together with the description of the exemplary embodiments, serve to explain the principles and implementations of the invention.

In the drawings:

FIG. 1 is a front perspective exploded view diagram of an adjustable tool holder in accordance with an embodiment.

FIG. 2 is a rear perspective exploded view diagram of an adjustable tool holder in accordance with an embodiment.

FIG. 3 is a front elevational view diagram of an adapter head for an adjustable tool holder in accordance with an embodiment.

FIG. 4 is a front elevational schematic diagram of a typical lathe in accordance with the prior art equipped with a collet-held cutting tool.

FIG. 5 is a front elevational schematic diagram of the lathe of FIG. 4 equipped with an adjustable tool holder in accordance with an embodiment wherein the cutting tool is of the boring bar type.

FIG. 6 is a front elevational schematic diagram of the lathe of FIG. 4 equipped with an adjustable tool holder in accordance with an embodiment wherein the cutting tool is of the collet-held type.

### DESCRIPTION OF EXAMPLE EMBODIMENTS

Exemplary embodiments are described herein in the context of an adjustable tool holder. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the exemplary embodiments as illustrated in the accompanying drawings. The same reference indicators will be used to the extent possible throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

References herein to “one embodiment” or “an embodiment” or “one implementation” or “an implementation” means that a particular feature, structure, part, function or characteristic described in connection with an exemplary embodiment can be included in at least one exemplary embodiment. The appearances of phrases such as “in one embodiment” or “in one implementation” in different places within this specification are not necessarily all referring to the same embodiment or implementation, nor are separate and alternative embodiments necessarily mutually exclusive of other embodiments.

In addition, while a particular feature of the subject innovation may be disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

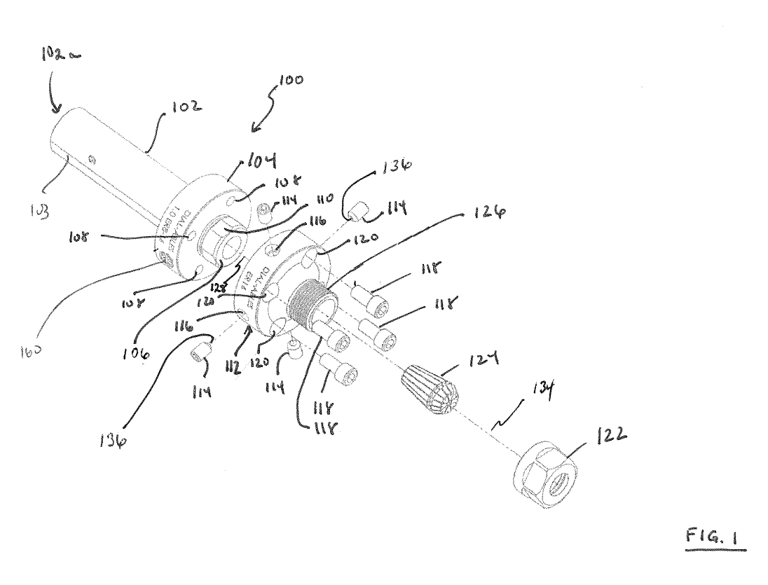

FIG. 1 is a front perspective exploded view diagram of an adjustable tool holder 100 in accordance with an embodiment. Tool holder 100 is intended to hold a tool bit in a fixed position relative to a workpiece turned by a source of rotary power (not shown). As shown in FIG. 1, the adjustable tool holder 100 includes a shank 102 with a longitudinal axis 128. Shank 102 is configured to be received at a proximal end 102a by a positionable tool holder of, for example, a lathe, a screw machine, a drill, a powered turning machine, and the like (collectively also referred to herein as “rotary power tools”). Shank 102 includes an alignment flat 103 and, at a distal end 102b, a mounting flange 104 having a tool shaft receiver 106 extending therefrom. Tool shaft receiver 106 is provided with a first plurality of 4 flats (flat surfaces) 110. Mounting flange 104 is also provided with a second plurality of 4 threaded apertures 108. Adapter head 112 provides the adjustment capability and is coupled to shank 102 in two ways. Firstly, a third plurality of 4 adjustment screws 114 engage a corresponding third plurality of threaded apertures 116 in adapter head 112. These adjustment screws 114, in turn, engage the corresponding first plurality of flats 110 of tool shaft receiver 106. Secondly, a fourth plurality of 4 lock screws 118 pass through corresponding fourth plurality of unthreaded apertures 120 in adapter head 112 and engage the corresponding second plurality of threaded apertures 108 of mounting flange 104 in order to lock adapter head 112 to shank 102 at mounting flange 104. In one embodiment a standard collet nut 122 holds a standard collet 124 to threaded portion 126 of adapter head 112 in order to retain a cutting tool (not shown).

In operation, a cutting tool or bit is inserted into the collet 124 which is positioned into a pocket machined into adapter head 112 concentrically with threaded portion 126. Collet nut 122 is passed over the tool and tightened by turning it onto threaded portion 126 of adapter head 112. Once tightened, collet nut 122 retains the cutting tool securely in adapter head 112 of tool holder 100.

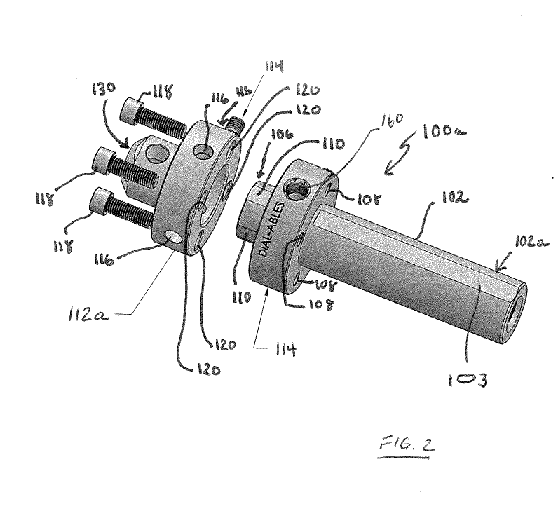

FIG. 2 is a rear perspective exploded view diagram of an adjustable tool holder in accordance with an alternative embodiment. In accordance with this alternative embodiment a boring bar adapter 130 is provided at adapter head 112a (instead of the collet assembly of parts 122, 124 and 126 shown in the FIG. 1 embodiment) to receive and fix a boring bar type of cutting tool to adjustable tool holder 100a. In all other material respects the device of FIG. 2 is the same as that of FIG. 1. The boring bar cutting tool (not shown) is coupled to the boring bar adapter 130 with, for example, set screws not shown).

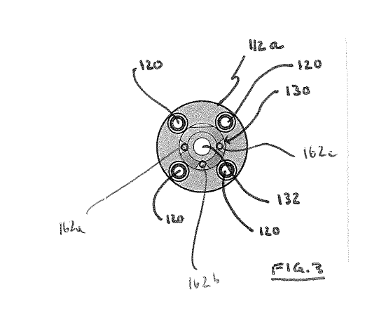

FIG. 3 is a front elevational view diagram of a boring bar adapter 130 in accordance with an embodiment. The boring bar tool (not shown) is inserted into central aperture 132 and held in place by one or more set screws (not shown) or by another suitable type of retention mechanism as known to those of ordinary skill in the art.

The goal is to bring the rotational axis of the source of rotary power and the longitudinal axis 134 of the cutting tool into coincidence. To align the longitudinal axis 134 of the cutting tool (not shown) precisely with the rotational axis of the source of rotary power, first the cutting tool (not shown) is secured in adapter head 112. Then the plurality of lock screws 118 are utilized to engage adapter head 112/112a to mounting flange 104 but left somewhat loose. The positioning is accomplished by contact between the bottom (distal end) 136 of each adjustment screw 114 with the corresponding flat 110 machined into tool shaft receiver 106 of the shank. Adjustment requires that one adjustment screw (114) be loosened slightly while an opposite adjustment screw (180 degrees opposite to it) is tightened. By repeating this adjustment process with the two (or more) pairs of adjustment screws (114) it is now possible to precisely position adapter head 112, and the cutting tool (not shown) inserted into and locked to it, so that the longitudinal axis 134 of the cutting tool and the axis of rotation of the source of rotary power are coincident (or set to a desired offset). Once adapter head 112 and the cutting tool (not shown) inserted into it have been so adjusted, the four (or more) lock screws 118 are fully tightened to insure that the position and alignment of the tool is maintained, and to securely lock adapter head 112 and the cutting tool into position on mounting flange 104 for cutting operations. For example, by placing a feeler gauge into the work piece chuck and using it to measure the relative position of the collet or boring bar as the workpiece chuck is rotated by hand, the reading on the feeler gauge can be zeroed out by sequentially adjusting the two (or more) pairs of adjustment screws 114.

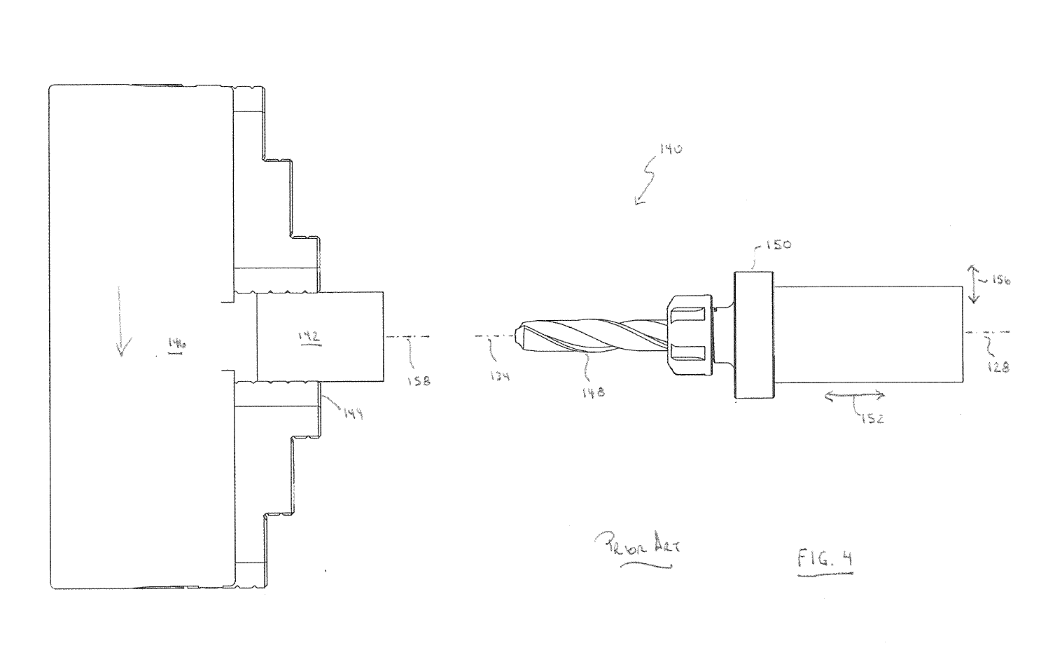

FIG. 4 is a front elevational schematic diagram of a typical lathe 140 in accordance with the prior art. A workpiece 142 is held in a workpiece chuck 144. The chuck 144 is mounted to a source of rotary power 146 which rotates the workpiece 142 in operation. A cutting tool 148 (such as a drill bit or a boring bar) is held in tool holder 150 which is mounted to a tool mounting assembly (not shown) which typically provides up to two degrees of movement (152, 156). Such tool mounting assemblies can be quite sophisticated and can include a rotary table with several tool selections. Tool mounting assemblies typically include a motor driven positioner (not shown) to position tool holder 150 along an axis 152 roughly parallel to the longitudinal axis 134 of cutting tool 148 and a motor driven positioner (not shown) to position tool holder 150 along an axis 156 roughly orthogonal to axis 152. Since three axes of adjustment are required to precisely position cutting tool 148 for work on workpiece 142, either precision suffers or the cutting tool 148 must be adjusted within tool holder 150 with shims and the like which, when cutting tool 148 needs to be replaced, also need to be replaced and readjusted, consuming valuable manufacturing time. Cutting tool 148 is used to cut rotating work piece 142 either along longitudinal axis 134 or at an offset to axis 134.

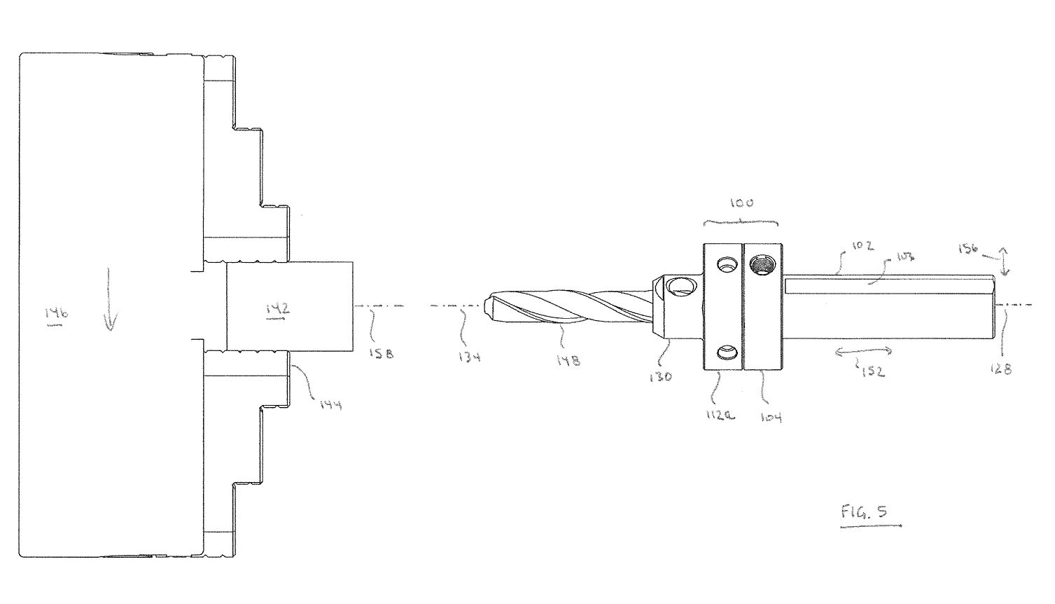

FIG. 5 is a front elevational schematic diagram of a typical lathe 10 equipped with an adjustable tool holder 100 in accordance with the present disclosure wherein the cutting tool is of the collet-held type. The adjustable tool holder 100 is mounted to tool mounting assembly (not shown) and holds cutting tool 148 (here illustrated as a boring bar). Mounting flange 104 and adapter head 112a provide two degrees of adjustability to permit precise alignment of longitudinal axis 134 of cutting tool 148 to longitudinal axis 158 of work piece 142 as described in more detail above.

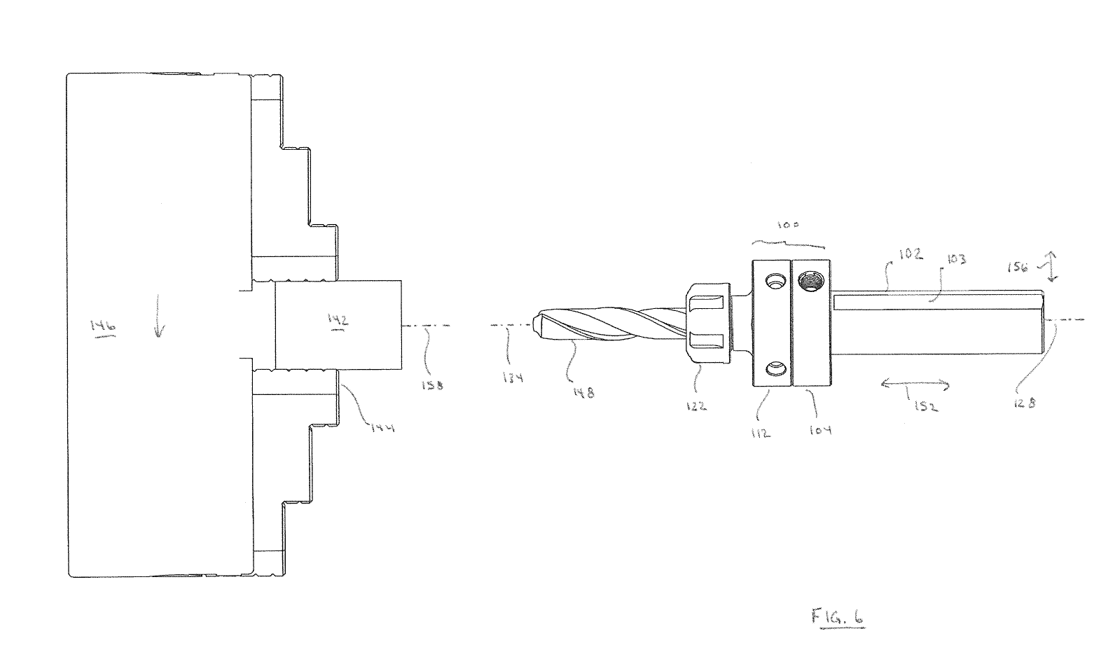

FIG. 6 is a front elevational schematic diagram of the lathe of FIG. 4 equipped with an adjustable tool holder in accordance with an embodiment wherein the cutting tool is of the collet-held type.

Cutting/cooling oil may be provided where desired as follows. For collet held cutting tools oil may be injected at inlet port 160 and pumped through the cutting tool 148 to a hole at the end of the cutting tool 148 to directly impinge in the work piece 142 at the area of the cut. In this case a portion of shank 102 is hollow to receive and channel the oil from inlet port 160, through mounting flange 104, through adapter head 112 and through the collet assembly 126, 124 and 122 to cutting tool 148. For boring bar-type cutting tools oil may be injected at inlet port 160 and pumped through the boring bar adapter 130 to one or more oil outlet ports 162a, 162b and 162c on boring bar adapter 130 to directly impinge the work piece 142 at the area of the cut. In this case a portion of shank 102 is hollow to receive and channel the oil from inlet port 160, through mounting flange 104, through boring bar adapter head 112a and through the outlet ports 162a, 162b and 162c.

Use of this approach results in less time spent in tool set up and alignment for machining, more accurate adjustment of tools than achievable by conventional adjustment methods (e.g., shims and the like), longer tool life, higher rigidity of the tool holder and cutting tool assembly, better finishes in the machined material (due to the improved rigidity), ability to machine harder materials with the same equipment, ability to accommodate smaller tools, and reduced wear on the turning machine.

While the above-described embodiment has four lock screws, four adjustment screws and corresponding apertures, other numbers of screws and apertures could be used without departing from the concept of the present invention and such arrangements are explicitly intended to be considered part of the present invention in accordance with the scope of the claims set out below.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

While exemplary embodiments and applications have been shown and described, it would be apparent to those skilled in the art having the benefit of this disclosure that numerous modifications, variations and adaptations not specifically mentioned above may be made to the various exemplary embodiments described herein without departing from the scope of the invention which is defined by the appended claims.

What is claimed is:

1. An adjustable tool holder, comprising:
a shank having a proximal end for attachment to a tool holder and a distal end including a mounting flange with a shaft receiver, the mounting flange having machined therethrough a plurality of threaded apertures and the shaft receiver having machined thereon a plurality of flats;
an adapter head configured to be coupled to the mounting flange, the adapter head having a plurality of threaded apertures machined therethrough and corresponding adjustment screws configured to engage the corresponding flats of the shaft receiver, the adapter head also having a plurality of unthreaded apertures configured to receive lock screws which engage corresponding threaded apertures of the mounting flange, the adapter head also configured to receive a cutting tool.

2. The adjustable tool holder of claim 1, wherein the tool holder is configured to adjust a distance between a longitudinal axis of the adapter head and a longitudinal axis of the mounting flange with adjustment of the adjustment screws.

3. The adjustable tool holder of claim 1, wherein the adapter head further includes a collet and a collet nut for securing the cutting tool to the adapter head.

4. The adjustable tool holder of claim 1, wherein the adapter head further includes a boring bar adapter and set screw for securing the cutting tool to the adapter head.

5. A method for securing a cutting tool to a tool holder and adjusting a position of a longitudinal axis of the cutting tool with respect to an axis of rotation of a source of rotary power rotating a workpiece, the method comprising:
providing an adjustable tool holder having a shank with a proximal end for attachment to the tool holder and a distal end including a mounting flange with a shaft receiver, the mounting flange having machined therethrough a plurality of threaded apertures and the shaft receiver having machined thereon a plurality of flats;
providing an adapter head configured to be coupled to the mounting flange, the adapter head having a plurality of threaded apertures machined therethrough and corresponding adjustment screws configured to engage the corresponding flats of the shaft receiver, the adapter head also having a plurality of unthreaded apertures configured to receive lock screws which engage corresponding threaded apertures of the mounting flange, the adapter head also configured to receive a cutting tool;
securing the cutting tool to the adapter head; and
adjusting the adjustment screws in order to adjust the position of the longitudinal axis of the cutting tool with respect to the axis of rotation of the source of rotary power.

6. The method of claim 5, further comprising:
tightening the lock screws to secure the adapter head to the mounting flange after the adjusting.

7. The method of claim 6, wherein:
the securing is accomplished with a collet and collet nut assembly.

8. The method of claim 6, wherein:
the securing is accomplished with a boring bar adapter and set screw.
